(19) United States
(12) Patent Application Publication
(10) Pub. No.: US 2003/0124501 A1
(43) Pub. Date: Jul. 3, 2003

(54) Display method and display apparatus

(76) Inventor: Kazutomi Mita, Kamakura-shi (JP)

Correspondence Address: Rocco S. Barrese, Esq., DILWORTH & BARRESE, LLP, 333 Earle Ovington Blvd., Uniondale, NY, 11553, US

(21) Appl. No.: 10/268,655

(22) Filed: Oct. 10, 2002

(30) Foreign Application Priority Data
Oct. 10, 2001 (JP) 2001-313 206
Aug. 30, 2002 (JP) 2002-252 974

(51) Int. Cl. G09B 7/00

(52) U.S. Cl. 434/322

(57) ABSTRACT

An aim of the present invention is to provide a technique for allowing a user to easily grasp an estimation result of an object.

A display method for displaying answers to a plurality of questions to estimate an approach of a company to an environment, the method comprising: preparing a plurality of leaf areas in which an answer result to each of the questions is displayed respectively, such that the leaf areas become a tree as a whole; obtaining answer indicating an attainment degree for each of the questions; and displaying a result by color-coding the leaf area corresponding to each of the questions with different colors such that the attainment degree of the answer is understood. The display apparatus prepay the leaf areas and displays the result, such that, the higher the estimation of the approach of the company to the environment is, the more green leaves the tree has.

### BACKGROUND OF THE INVENTION

1. Field of the Invention

This invention relates to a method for displaying a result of estimation of an object. In particular, this invention relates to a display method for displaying answers to a plurality of questions to estimate an object.

2. Description of the Related Art

In recent years, a purchaser has come to select which company the purchaser uses, by making much of not only a direct charge but also company's moral and policy when the purchaser receives service or purchases a product from a company. Along this line, an estimation result which is obtained by estimation of an approach of a company to environmental problems or a management condition of a company from answers to a variety of questions, has come to be often released to general purchasers as a criterion.

However, as long as the estimation result is merely converted into numbers or is only indicated by a ranking which compares a many with other companies, there is a problem that a company which is an object of estimation is unclear as to an issue or point so as to make it impossible to grasp a point to be solved. In addition, there is a problem that general purchasers which use the estimation result can not grasp the estimation result at a glance.

### SUMMARY OF THE INVENTION

The present invention is made in view of the foregoing problems, and an aim of the present invention is to provide a technique for allowing a user to easily grasp an estimation result of an object.

An aspect of the present invention relates to a method for displaying answers to a plurality of questions to estimate a certain object. This method prepares an area for each of the questions in which an answer result to each of the questions is displayed, and the method obtains an answer indicating an attainment degree for each of the questions, and displays a result in the area corresponding to each of the questions such that the attainment degree of the answer is understood.

The estimation may be performed from a predetermined aspect, and the area may be prepared such that a drawing which symbolizes the predetermined aspect is drawn by the area. The area may be color-coded with different colors according to the attainment degree of the answer for each of the questions. For example, in the case of estimating a certain object from an environmental aspect, the area is prepared such that a “tree” is drawn as a drawing which symbolizes the environmental aspect. Here, the area is a “leaf.” The area may be color-coded with “green,” “yellow” or “red,” according to the attainment degree.

Another aspect of the present invention relates to a method for displaying answers to a plurality of questions to estimate an approach of a company to an environment. This method prepares a plurality of leaf areas in which an answer result to each of the questions is displayed respectively, such that the leaf areas become a tree as a whole, and the method obtains an answer indicating an attainment degree for each of the questions, and displays a result by color-coding the leaf area corresponding to each of the questions with different colors such that the attainment degree of the answer is understood. The leaf areas may be prepared and the result may be displayed, such that, the higher the estimation of the approach of the company to the environment is, the more green leaves the tree has.

Still another aspect of the present invention relates to a display apparatus. This display apparatus comprises: a first display portion for displaying a plurality of questions to estimate a certain object from a predetermined aspect; an answer receipt portion for receiving an answer indicating an at at degree for each of the questions; and a second display portion for displaying the answer to each of the questions. The second display portion prepares a plurality of display areas in which an answer result to each of the questions is displayed respectively, such that the display areas become a drawing which symbolizes the predetermined aspect, and the second display portion displays a result in each area corresponding to each of the questions such that the attainment degree of the answer for the question is understood.

According to the present invention, there is provided a display method for displaying answers to a plurality of questions to estimate a certain object, by using a display apparatus including a display portion and an input receipt portion, the method comprising the steps of: receiving, at the input receipt portion, answers indicating attainment degrees for the plurality of questions; and preparing, at the display portion, an area for each of the questions in which an answer result to each of the questions is displayed, and displaying a result in the area corresponding to each of the questions such that the attainment degree of the answer is understood.

The estimation may be performed from a predetermined aspect, and the display portion may prepare the area such that a drawing which symbolizes the predetermined aspect is drawn by the area, in the step for displaying.

In the step for displaying, the display portion may color-code the area with different colors according to the attainment degree of the answer for each of the questions.

According to the present invention, there is provided a display method for displaying answers to a plurality of questions to estimate an approach of a company to an environment, by using a display apparatus including a display portion and an input receipt portion, the method comprising the steps of: receiving, at the receipt portion, answers indicating attainment degrees for the plurality of questions; and preparing, at the display portion, a plurality of leaf areas in which an answer result to each of the questions is displayed respectively, such that the leaf areas become a tree as a whole, and displaying a result by color-coding the leaf area corresponding to each of the questions with different colors such that the attainment degree of the answer is understood.

In the step for displaying, the display portion may prepare the leaf areas such that, the higher the estimation of the approach of the company to the environment is, the more green leaves the tree has.

According to the present invention, there is provided a display apparatus comprising: an answer hold portion for holding answers indicating attainment degrees to a plurality of questions to estimate a certain object, by bringing the answers into correspondence with the questions, respectively; and a display portion for preparing an area for each of the questions in which an answer result to each of the questions is displayed, and for displaying a result in the area corresponding to each of the questions such that the attainment degree of the answer is understood.

The estimation may be performed from a predetermined aspect, and the display portion may prepare the area such that a drawing which symbolizes the predetermined aspect is drawn by the area.

The display portion may color-code the area with different colors according to the attainment degree of the answer for each of the questions.

According to the present invention, there is provided a display apparatus comprising: an answer hold portion for holding answers indicating attainment degrees to a plurality of questions to estimate an approach of a company to an environment, by bringing the answers into correspondence with the questions, respectively; and a display portion for preparing a plurality of leaf areas in which an answer to each of the questions is displayed respectively, such that the leaf areas became a tree as a whole, and for displaying a result by color-coding the leaf area corresponding to each of the questions with different colors according to the attainment degree of the answer.

A display apparatus of the present invention further comprises: a browse processing portion for allowing the display portion to display the answer result after performing a predetermined authentication based on a browse request for the answer result.

A display apparatus of the present invention may be connected to a network, and the display portion may perform a processing of displaying the answer result on another terminal connected to the network.

According to the present invention, there is provided a display apparatus comprising: a first display portion for displaying a plurality of questions to estimate a certain object from a predetermined aspect; an answer receipt portion for receiving an answer indicating an attainment degree for each of the questions; and a second display portion for displaying an answer result to each of the questions; wherein the second display portion prepares a plurality of display areas in which the answer result to each of the questions is displayed respectively, such that the display areas become a drawing which symbolizes the predetermined aspect, and the second display portion displays a result in each area corresponding to each of the questions such that the attainment degree of the answer for the question is understood.

This display apparatus may further comprises: an answer hold portion for holding answers which the answer receipt portion have received; and a browse processing portion for allowing the second display portion to display the answer after performing a predetermined authentication based on a browse request for the answer.

The second display portion may display the answer along with a date and time when the answer was received.

A display apparatus of the present invention may be connected to a network, and the second display portion may perform a processing of displaying the answer result on another terminal connected to the network.

Additionally, conversions from one into another among a method, an apparatus, a system, a recording media and a program, of the expression of the present invention, and an arbitrary combination of the foregoing components, are effective as an aspect of the present invention.

### BRIEF DESCRIPTION OF THE DRAWINGS

FIG. 1 is a view for showing a portion of a check sheet according to an embodiment;

FIG. 2 is a view for showing an example of a rating map according to an embodiment:

FIG. 3 is a view for showing an example of a visual sheet according to an embodiment;

FIG. 4 is a view for showing an example of a rating calculation document according to a first embodiment;

FIG. 5 is a block diagram for showing a display apparatus according to an embodiment;

FIG. 6 is a view for showing a network composition including a rating system which is a display apparatus according to a second embodiment;

FIG. 7 is a block diagram for showing a composition of the rating system shown in FIG. 6;

FIG. 8 is a flow chart showing a rating processing of the rating system shown in FIG. 7; and

FIG. 9 is a flow chart showing a processing of making rating data visible and displaying it, based on a browse request from a user terminal.

### DESCRIPTION OF THE PREFERRED EMBODIMENTS

### First Embodiment

In a first embodiment of the present invention, the aim is to allow a user to easily grasp an estimation result of an object by making the estimation of the object be in a game form and visible. In this estimation, a check sheet on which a plurality of questions are written, a rating map, a visual sheet and a rating calculation document are utilized.

In the present embodiment, for example, taking a company as an object, an estimation is performed from three aspects, A: management aspect, B: environmental aspect, and C: moral aspect. In addition, for each aspect, the estimation is performed based on a plurality of items. For example, A: management aspect is estimated based on three items, a: idea, b: information, and c: risk. Further, each item is estimated based on a plurality of estimation contents. For example, the estimation contents include 1: strategy, 2: organization and 3: legality. An answer indicating an attainment degree for the question which is set for each estimation content of each item, is obtained, and the estimation of the object is performed from the result.

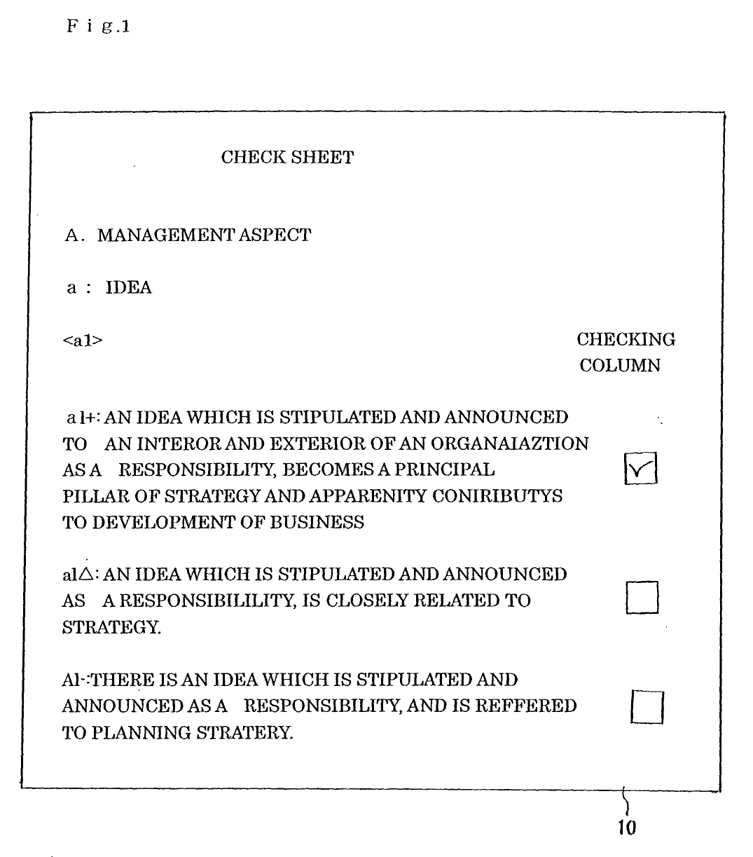

FIG. 1 shows a portion of a check sheet 10. Here, for example, a question is shown in which the aspect is “A: management aspect,” the item is “a: idea,” and the estimation content is “1: strategy.” A question in which the item is “a: idea,” and the estimation content is “1: strategy,” is hereinafter referred to as a1. a1 includes three questions, a1+, a1Δ and a1-−, a1+, a1Δ and a1− indicate an attainment degree which is set to be higher in the order, a1+, a1Δ and a1-−. In order from a1+, an answerer checks whether the answerer corresponds to the question or not. For example, in the case that the answerer corresponds to the question a1+ “ an idea which is stipulated and announced to an interior and exterior of an organization as a responsibility, becomes a principal pillar of strategy, and apparently contributes to development of business,” the answerer checks this item. In the case of corresponding to the a1+, it means the highest degree of attainment in a1 so that the answers to the items a1Δ and a1− may be omitted. Similarly, in the case of corresponding to a1Δ, the answer to the item a1− can be omitted. In addition, in the case that of corresponding to no items, the does not check any of the items.

The answer showing the attainment to the question may be obtained in such a way as “+: corresponding very much, Δ: corresponding to a certain extent, −: sometimes corresponding, none: not corresponding at all” to one question.

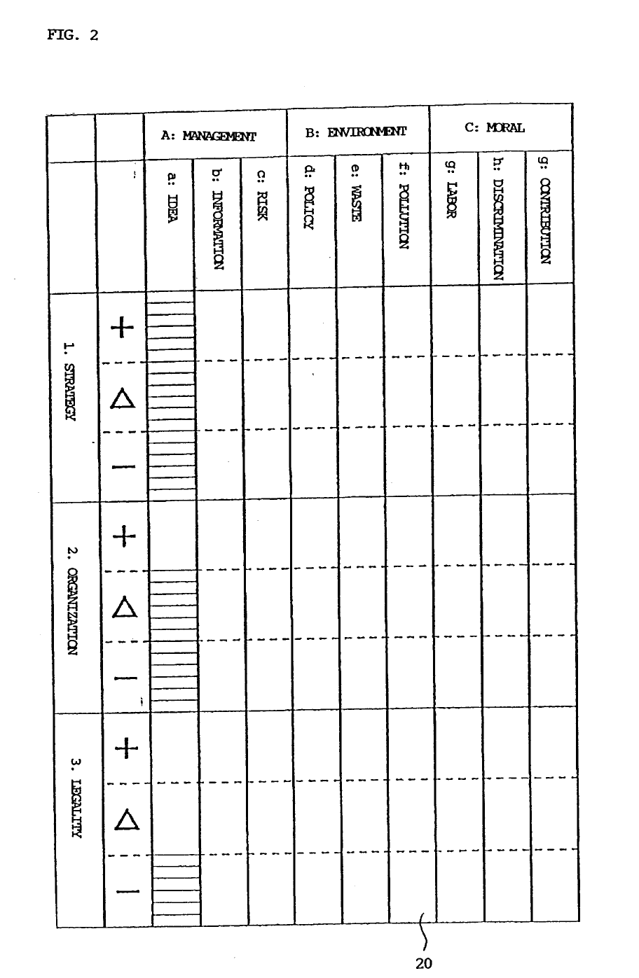

FIG. 2 shows an example of a rating map. A rating map 20 includes a plurality of aspect columns and a plurality of item columns which are included in each of the aspect columns on a horizontal axis, and estimation content columns on a vertical axis. Here, with respect to each item, a question is set for each of the estimation contents. The answer indicating an attainment degree for each of the questions is displayed by color-coding cells within a frame at which each item and each estimation content intersect. In the present embodiment, three cells are included within each frame because an attainment degree for each of the questions is indicated in four stages, “+,” “Δ,” “−” and “none.” In the case that an answerer checks “+” for a question, three cells within the frame are color-coded. Similarly, in the case that an answerer check “Δ,” two cells within the frame are color-coded, and in the case of “−,” one cell within the frame is color-coded. In the case that an answerer checks none, no cells within the frame are color-coded.

For example, in the case that an answerer checks “+” for a1 question on the check sheet of FIG. 1, as shown in FIG. 2, three cells within the frame in which “a: idea” and “1: strategy” intersect are color-coded. In addition, in the case that an answerer checks “Δ” for a2 question, two cells within the frame in which “a: idea” and “2: organization” intersect are color-coded. Further, in the case that an answerer checks “−” for a3 question, one cell within the frame in which “a: idea” and “3: legality” intersect is color-coded.

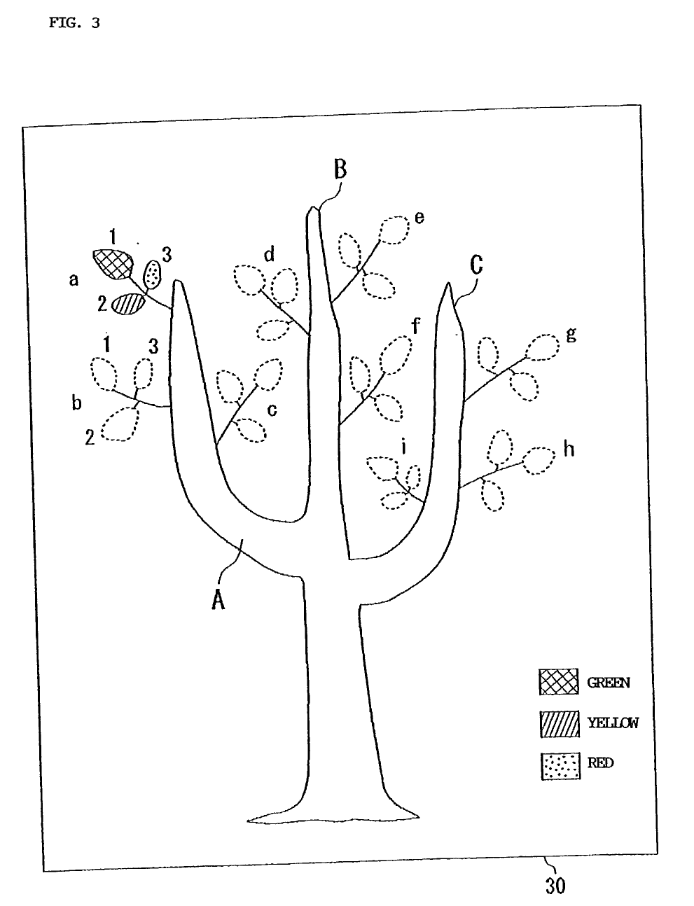

FIG. 3 shows an example of a visual sheet. In the present embodiment, a tree is schematically indicated on a visual sheet 30. This “tree” has three “trunks” which have three “branches” respectively, which further have three “leaves” respectively. Here, the “trunks” indicate aspects, the “branches” indicate items, and the “leaves,” indicate estimation contents of each items. That is, the trunk A has branches corresponding to items a to c of management aspect, the branch a has leaves which indicate the answer results to questions of the estimation contents 1 to 3 in “a: idea.”

Referring to FIG. 2 here, since “+” is already checked in a1, a leaf 1 of the branch a is color-coded to be green. Similarly, a leaf 2 of the branch a is color-coded to be yellow, and a leaf 3 of the branch a to be red. In addition, a leaf corresponding to a question in which there are no checks in “+,” “Δ” and “−” is not color-coded.

It is preferable that a drawing which symbolizes the aspects of estimation of the object be drawn on a visual sheet 30. For example, in the present embodiment, a “tree” which symbolizes an environment is displayed because a company is estimated in view of its contribution to the environment. In addition, the object which is a symbolizing drawing has preferably a large part, a middle part, a small part and the like. Here the object is a “tree,” the large part is a “trunk,” the middle part is a “branch”, and the small part is a “leaf”. Questions from which the object is estimated are classified according to their kind, into a large classification, a middle classification, a small classification and the like. Further, these are allowed to correspond in such a way that the large classification corresponds to a large part, the middle classification a middle part, and the small classification a small part, respectively. Here, the large classification is aspects, the middle classification is items, and the smell classification is estimation contents in each item.

In addition, the object is preferably displayed in such a way that, the higher the estimation of the aspect from which the object is estimated, the more the fruitage is clearly displayed. That is, the “tree” which is the object in the present embodiment is preferably displayed, such that, the higher the estimation of the approach of the company to the environment is, the more green leaves the tree has. In the present embodiment, when the attainment degree for each of the questions is higher, the result of the answers is displayed by the more green leaves so that an more exuberant tree with green leaves is displayed on the visual sheet 30. When seeing this visual sheet 30, the user can grasp the estimation result at a glance. Moreover, since a plurality of questions are classified and indicated per each part, the side of the company which is the object of the estimation can easily abstract the questions corresponding to the portions which are less exuberant with green leaves in the visual sheet 30 and grasp the points which should be improved.

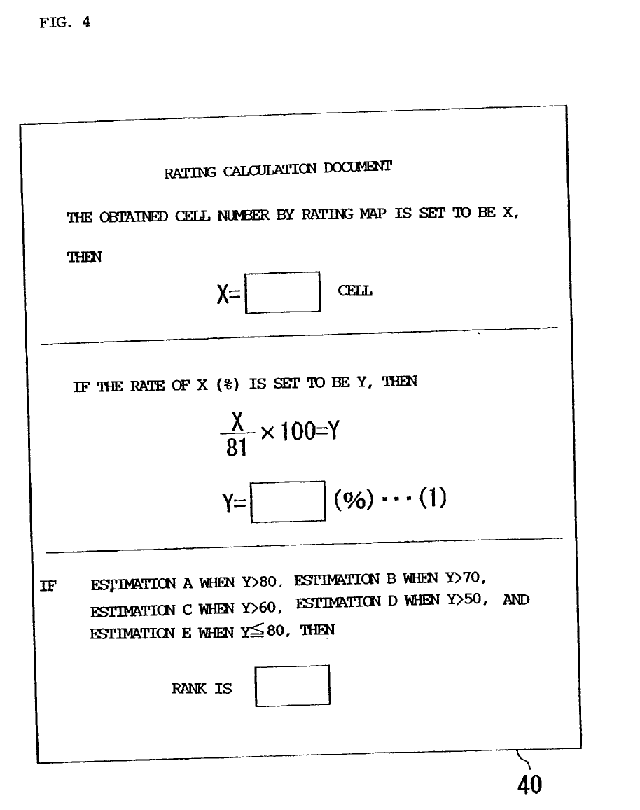

FIG. 4 shoos an example of a rating calculation document. This rating calculation document 40 is used in connection with the rating ma 20 which is shown in FIG. 2 The answerer counts the number of the cell or cells color-coded by the rating map 20 and calculates a rank using the rating calculation document 40. In FIG. 2, there are 81 cells in total. Among these, the color-coded cells are counted and the number is set to be an obtained cell number X. When the cell nu X is input, Y which is a rate of X (%) can be calculated based on a formula (1). The ranking into A to E is performed based on the calculated value of Y.

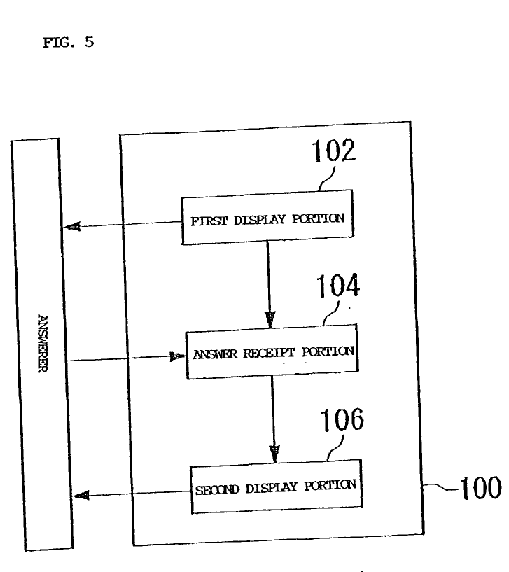

FIG. 5 is a block diagram showing a display apparatus which realizes a display method of the estimation results which have been explained by reference to FIG. 1 to FIG. 4. A display apparatus 100 crises, a first display portion 102 for displaying a plurality of questions to estimate an object from a predetermined aspect, an answer receipt portion 104 for receiving an answer indicating an attainment degree for each of the questions, and a second display portion 106 for displaying an answer to each of the questions. The second display portion 106 prepares a plurality of display areas in which the answer result to each of the questions is displayed respectively such that the display areas become a drawing which symbolizes the predetermined aspect, and the second display portion 106 displays the results in each area corresponding to each of the questions such that an attainment of the answer to the question is understood.

The display apparatus 100 may o a bold portion for holding an answer to each of the questions on the check sheet 1 shown in FIG. 1, and a location and color-coding of each leaf on the visual sheet 30 shown in FIG. 3 by allowing the answer and the location and color-coding to correspond to each other. In this case, the visual map 30 may be directly displayed on the second display portion 106 after receiving answers from answerers without utilizing the rating map 20 in FIG. 2.

The display apparatus 100 may comprise a hold portion for holding an answer to each of the questions on the check sheet 1 shown in FIG. 1, and a location of each frame on the rating map 20 shown in FIG. 2 by allowing the answer and the location to correspond to each other. In this case, cells of applicable number may be color-coded within the corresponding frame of the rating map 20 in FIG. 2, after receiving answerers.

Further, the display apparatus 100 may comprise a calculation portion for automatically calculating an obtained cell number X in the rating calculation document 40 shown in FIG. 4, based on an answer to each of the questions on the check sheet 10 shown in FIG. 1. In this case, the calculation portion may calculate Y based on the formula (1). In addition, the calculation portion may perform a ranking of the object based on the calculated Y value.

### Second Embodiment

In an embodiment of the present invention, an example will be explained in which the display apparatus 100 shown in FIG. 5 of the first embodiment is utilized as a rating system of a company. In the second embodiment, also, the check sheet 10, the rating map 20, the visual sheet 30 and the rating calculation sheet 40 as shown in FIG. 1 to 4, are utilized for estimation of a company.

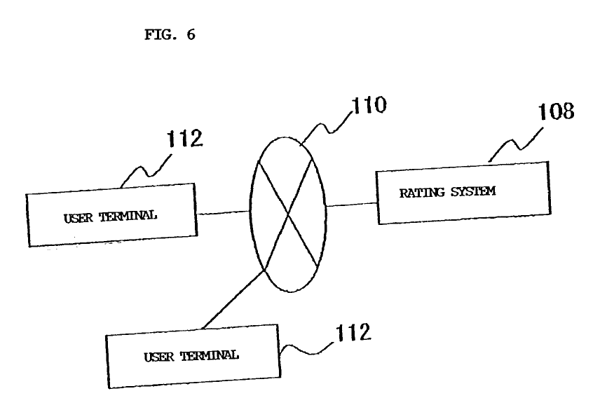

FIG. 6 is a block diagram showing a network composition including a rating system 108. The rating system 108 delivers and receives data to and from a user terminal via a network 110. The rating system 108 is operated by, for example, an organization which estimates an approach of a company to an environment to perform a rating of the company. The rating system 108 performs a rating processing of a company based on an estimation request from the company, and provides a service, such as browsing of the rated results based on a browse request from the company, other companies, general consumers and the like.

The composition of the rating system 108 is realized by a CPU of an arbitrary computer, a memory and other elements, if defined as hardware components, and a program having a rating processing function loaded into a memory, and the like, as software. However, functional blocks realized by linkages of these components are indicated here. Therefore, it is to be understood by a person with ordinary skill in the art that these functional blocks can be realized in various forms by hardware only, software only, or the combination thereof.

In the present embodiment, the user terminal 112 is a terminal used by companies or common consumers. The user terminal 112 may be any hardware if it is able to communicate with the rating system 108 via the network 110 and to display a rated result. For example, the user terminal 112 can be a PC, a PDA, a mobile phone, and other arbitrary hardware.

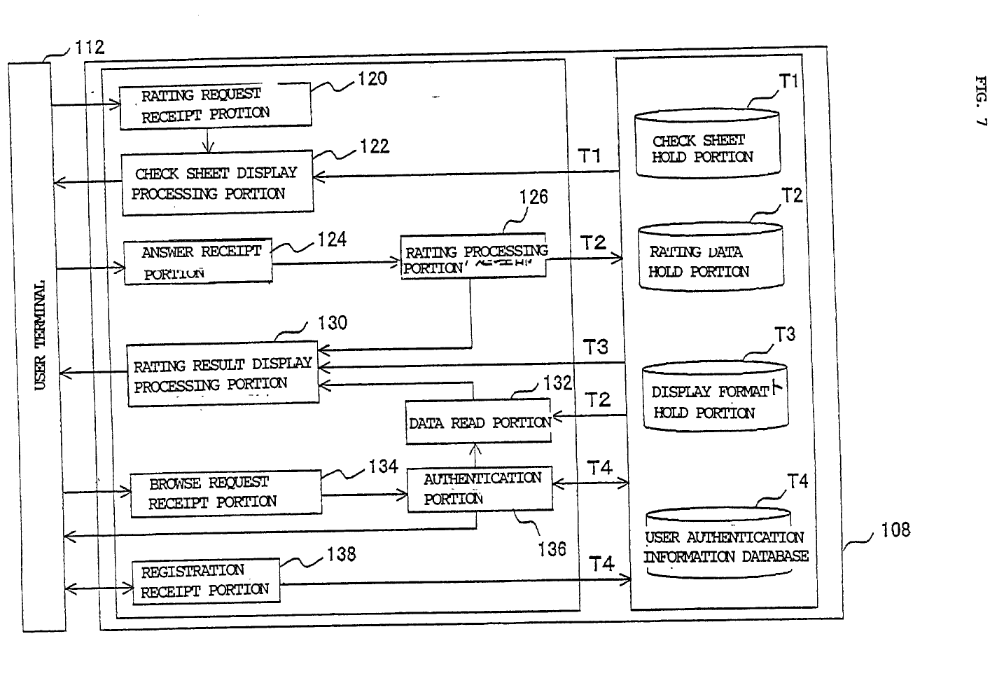

FIG. 7 is a block diagram showing a composition of the rating system 108. The rating system 108 has a rating request receipt portion 120, a check sheet display processing portion 122, an answer receipt portion 124, a rating processing portion 126, a rating result display processing portion 130, a data read portion 132, an browse request receipt portion 134, a authentication portion 136 and a registration receipt portion 138. The rating system 108 further has a check sheet hold portion T1 for holding a check sheet 10 (see FIG. 1), a rating data hold portion T2 for holding answers to the check sheet 10, and the like, a display format hold portion T3 for holding formats of a rating map 20 (see FIG. 2), a visual sheet 30 (see FIG. 3), a rating calculation document 40 (see FIG. 4) and the like, and a user authentication information database T4.

The rating request receipt portion 120 receives requests of rating from the user terminal 112 via the network 110. When the rating request receipt portion 120 receives a request of rating, the check sheet display processing portion 122 reads the check sheet 10 from the check sheet hold portion T1 and performs a processing of displaying the check sheet 10 on the user terminal 112 via the network 110. The processing of displaying mentioned here, may be a processing of displaying the check sheet 10 on a Web page provided by the rating system 108, or displaying the check sheet 10 by transmitting it to the user tern 112 by e-mail and the like. The answer receipt portion 124 receives an answer indicating an attainment for each of the questions on the check sheet 10 from the user terminal 112.

The rating processing portion 126 calculates X and Y in the rating calculation dent 40 based on the answer to each of the questions on the check sheet 10 and performs a ranking of the company. The rating processing portion 126 stores the answers received by the answer receipt portion 124 and the result of the ranking (hereafter simply referred to as “rating data”) in the rating data hold portion T2, by allowing the rating data to correspond to the company.

The rating result display processing portion 130 receives the rating data from the rating processing portion 126. In addition, the display format hold portion T3 holds the format of the visual sheet 30 such that each of the questions on the check sheet 10 corresponds to the location of each leaf in the visual sheet 30. Furthermore, the display format hold portion T3 holds the format of the rating map 20 such that each of the questions on the check sheet 10 corresponds to the location of each frame in the rating map 20. The rating result display processing portion 130 reads the formats of the rating map 20 and the visual sheet 30 from the display format hold portion T3 so as to perform a processing of displaying the answers received from the rating prosing portion 126 on the user terminal 112 such that the answers reflect on the rating map 20 and the visual sheet 30.

The registration receipt portion 138 receives user registration from the user who wishes to browse the rating data of each company held in the rating data hold portion T2. The registration receipt portion 138 here can receive the user registration by allowing the user to identify the company the rating data of which the user wishes to browse. In addition, the user registration does not always have to be performed via the network 110. It may be performed for example, by receiving an application for user registration sent by mail and inputting necessary information by an operator of the rating system 108. When the user registration is performed under such a predetermined procedure, the registration receipt portion 138 transmits user authentication information such as a user ID, a password and the like, to the user, and also stores the user authentication information in the user authentication information database T4. The registration receipt portion 138 stores in the user authentication information database T4 the user authentication information of each user in such a way that the information is allowed to be in relation to the company which the user has identified to make application for the registration.

The browse request receipt portion 134 receives an browse request for the rating data from the user terminal 112. The browse request receipt portion 134 requests the user terminal 112 to transmit the user authentication information, when the browse is requested from the user terminal 112. When the user terminal 112 transmits the user authentication information and the designation of the company which the user wishes to browse, the authentication portion 136 checks the user authentication information by reference to the user authentication information database T4 so as to judge whether the user is authorized to browse the rating data of the designated company or not. When the user authentication information matches, the data read portion 132 reads the rating data of the designated company from the rating data hold portion T2. When the user authentication information does not match, the authentication portion 136 provides to the user terminal 112 a notification that the browse is not available. The rating result display processing portion 130 allows the user terminal 112 to display the rating map 20, the visual sheet 30, the rating calculation document 40 or the like by the similar processing to the processing of making the above-mentioned rating data.

In addition, the rating processing portion 126 can store in the rating data hold portion T2 the rating data along with the time when the answer receipt portion 124 receives the answers to the check sheet 10 from the user terminal 112. The rating result display processing portion 130 can display the rating map 20 and the visual sheet 30 along with the time when the above-mentioned answers are received. As a result, the browser of the rating map 20 and the visual sheet 30 can know when the rating data is made and can judge the rating of the company appropriately.

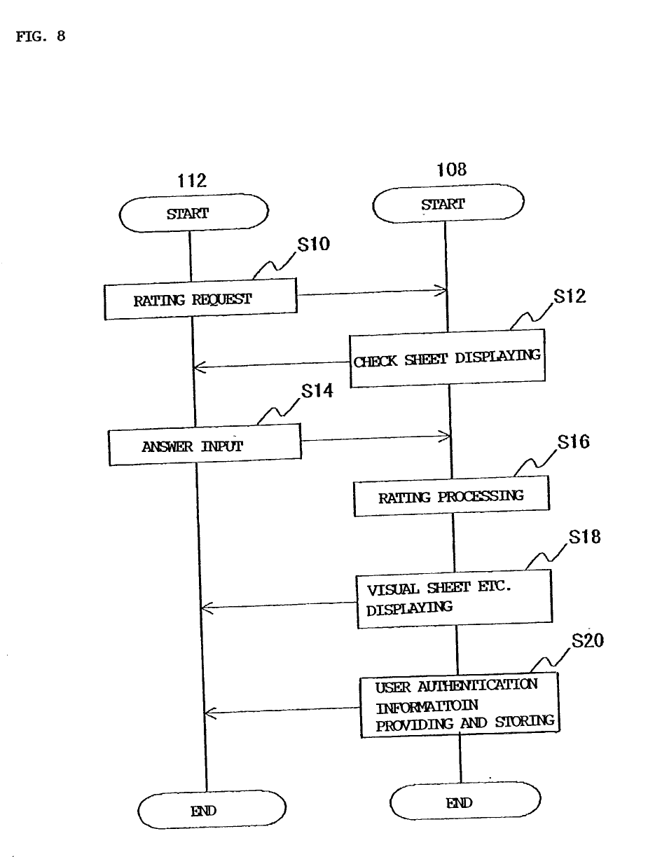

FIG. 8 is a flow chart showing the processing in which the rating system 108 performs the rating based on the request from the user terminal 112 and displays the results. When a rating is requested from the user terminal 112 (S10), the check sheet display processing portion 122 reads the check sheet from the check sheet hold portion T1 and performs the processing of displaying it on the user terminal 112 (S12). When the answer to each of the questions on the check sheet is input from the user terminal 112 (S14), the rating processing portion 126 performs the rating processing based on the answers (S16). And then, the rating result display processing portion 130 performs the processing of displaying on the user terminal 112 the rating map 20, the visual sheet 30 and the rating calculation document 40 on which the answers from the user terminal 112 reflect (S18). At this time, the registration receipt portion 138 provides the user authentication to the user terminal 112 and also stores the user authentication information in the user authentication information database T4 (S20). Up to this point, the rating processing is completed.

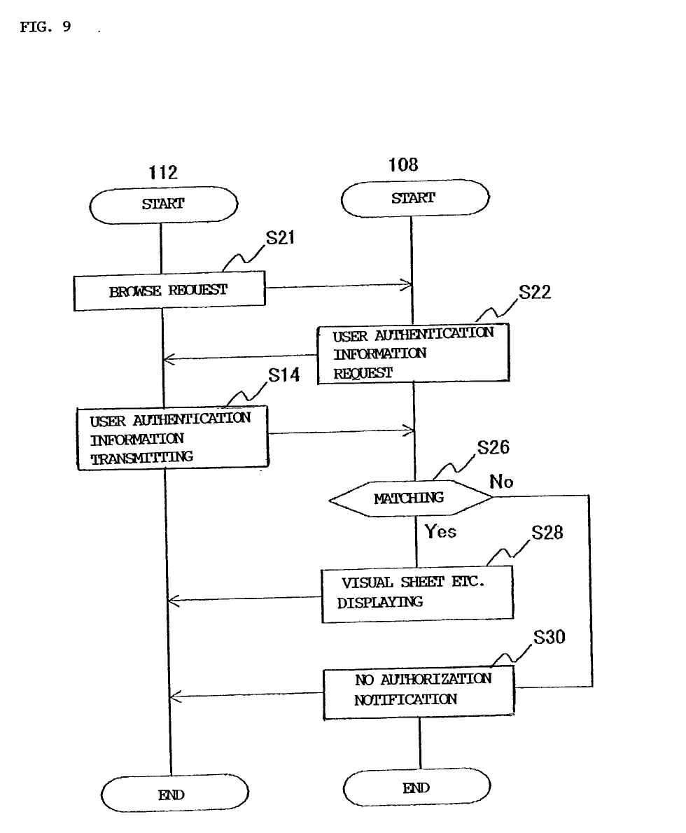

FIG. 9 is a flow chart showing a processing of displaying on the user terminal 112 the rating data stored in the rating data hold portion T2, in the form of the rating map 20, the visual sheet 30 or the rating calculation document 40, w the is requested from the user terminal 112 after the above-mentioned rating processing. Here, the user terminal 112 may be a terminal of the the rating of which is performed, or a terminal of general consumers and the like who make application for the registration. In addition, the organization which operates the rating system 108 can seal the rating data as a report in paper media. In this case, the user authentication information is also provided to the purchaser of the paper media report, and also the user authentication information can be stored in the user authentication information database T4. Accordingly, even in the case of purchasing the paper media report, the purchaser can obtain the latest information by accessing the rating system 108 at any time.

When the browse of the rating data is requested from the user terminal 112 (S21), the browse request receipt portion 134 requests the user terminal 112 to transmit the user authentication information (S22). When the user authentication information is transmitted from the user terminal 112 (S24), the authentication portion 136 judges whether the user authentication information matches or not by reference to the user identifying information database T4 (S26). When the user authentication information matches (Yes in S26), the data read portion 132 reads the rating data of the applicable company from the rating data hold portion T2, and the rating result display processing portion 130 performs a processing of displaying the rating data in the form of the visual sheet 30 or the like (S28). In the case that the user authentication information does not match in step 26 (No in S26), the authentication portion 136 informs the user terminal 112 that the rating data cannot be browsed (S30).

The present invention has been explained above based on the embodiments. It is to be understood by a person with ordinary skill in the art that the embodiments are illustrative, there can be various modification examples in the combination of the respective components and the respective processing process of the embodiments, and such modification examples are within the scope of the present invention.

In the embodiments, the examples in which a company as an object is estimated mainly from an environmental aspect have been show. However, the display method and the display apparatus according to the present invention can be used in the case of estimating a variety of objects from various aspects.

In the second embodiment, the rating data is adapted to be able to be browsed after receiving the authentication by the authentication portion 136. However, there can be a construction in which the rating data can be freely. Accordingly, general consumers can easily estimate a company, for example, in view of its approach to an environment.

Moreover, in the second embodiment, the rating data hold portion T2 can hold data in which the rating data reflecting on the forms of the rating map 20, the visual sheet 30 and the rating calculation document 40. Accordingly, the rating result display processing portion 130 can allow the user terminal 112 to display the rating data in a visualized condition just by reading the data from the rating data hold portion T2.

In the embodiments of the present invention, a user can be allowed to easily grasp an estimation result of an object by making the estimation of the object be in a game form and visible.

What is claimed is:

1. A display method for displaying answers to a plurality of questions to estimate a certain object, by using a display apparatus including a display portion and an input receipt portion, the method comprising the steps of:
receiving, at the input receipt portion, answers indicating attainment degrees for the plurality of questions; and
preparing, at the display portion, an area for each of the questions in which an answer result to each of the questions is displayed, and displaying a result in the area corresponding to each of the questions such that the attainment degree of the answer is understood.

2. A display method according to claim 1, wherein the estimation is performed from a predetermined aspect, and the area is prepared such that a drawing which symbolizes the predetermined aspect is drawn by the area, at the display portion in the step for displaying.

3. A display method according to claim 1 or 2, wherein the area is color-coded with different colors according to the attainment degree of the answer for each of the questions, at the display portion in the step for displaying.

4. A display method for displaying answers to a plurality of questions to estimate an approach of a company to an environment, by using a display apparatus including a display portion and an input receipt portion, the method comprising the steps of:
receiving, at the receipt portion, answers indicating attainment degrees for the plurality of questions; and
preparing, at the display portion, a plurality of leaf areas in which an answer result to each of the questions is displayed respectively, such that the leaf areas become a tree as a whole, and displaying a result by color-coding the leaf area corresponding to each of the questions with different colors such that the attainment degree of the answer is understood.

5. A display method according to claim 4, wherein the leaf areas are prepared at the display portion in the step for displaying, such that, the higher the estimation of the approach of the company to the environment is, the more green leaves the tree has.

6. A display apparatus comprising:
an answer hold portion for holding answers indicating attainment degrees to a plurality of questions to estimate a certain object, by bringing the answers into correspondence with the questions, respectively; and
a display portion for preparing an area for each of the questions in which an answer result to each of the questions is displayed, and for displaying a result in the area corresponding to each of the questions such that the attainment degree of the answer is understood.

7. A display apparatus according to claim 6,
wherein the estimation is performed from a predetermined aspect, and
wherein the display portion prepares the area such that a drawing which symbolizes the predetermined aspect is drawn by the area.

8. A display apparatus according to claim 6 or 7, wherein the display portion color-codes the area with different colors according to the attainment degree of the answer for each of the questions.

9. A display apparatus comprising:
an answer hold portion for holding answers indicating attainment degrees to a plurality of questions to estimate an a of a company to an environment, by bringing the answers into correspondence with the questions, respectively; and
a display portion for preparing a plurality of leaf areas in which an answer to each of the questions is displayed respectively, such that the leaf areas became a tree as a whole, and for displaying a result by color-coding the leaf area corresponding to each of the questions with different colors according to the attainment degree of the answer.

10. A display apparatus according any of claims 6 to 9, further comprising:
a browse processing portion for allowing the display portion to display the answer result after performing a predetermined authentication based on a browse request for the answer result.

11. A display apparatus according to claim 10,
wherein the display apparatus is connected to a network, and
wherein the display portion performs a processing of displaying the answer result on another terminal connected to the network.

12. A display apparatus comprising:
a first display portion for displaying a plurality of questions to estimate a certain object from a predetermined aspect;
an answer receipt portion for receiving an answer indicating an attainment degree for each of the questions; and
a second display portion for displaying an answer result to each of the questions;
wherein the second display portion prepares a plurality of display areas in which the answer result to each of the questions is displayed respectively, such that the display areas become a drawing which symbolizes the predetermined aspect, and the second display portion displays a result in each area corresponding to each of the questions such that the attainment degree of the answer for the question is understood.
